(19) United States
(12) Patent Application Publication
(10) Pub. No.: US 2026/0189760 A1
(43) Pub. Date: Jul. 2, 2026

(54) VIDEO DISTRIBUTION SYSTEM, STORAGE MEDIUM, AND VIDEO DISTRIBUTION METHOD

(71) Applicant: CANON KABUSHIKI KAISHA, Tokyo (JP)

(72) Inventors: MAMORU KATAHIRA, Saitama (JP); YUYA YANAGI, Shizuoka (JP); SATOSHI TAKAMI, Kanagawa (JP); NAOKI ONO, Kanagawa (JP)

(21) Appl. No.: 19/427,373

(22) Filed: Dec. 19, 2025

(30) Foreign Application Priority Data
Dec. 27, 2024 (JP) 2024-232156

(51) Int. Cl. H04N 21/4722; H04N 21/475

(52) U.S. Cl. CPC H04N 21/4722; H04N 21/4756

(57) ABSTRACT

A video distribution system provides a service for distributing video where the system causes a display device of a mobile device to display a selections screen in a ranking format that enables a user to select a video to be distributed and where the display device is caused to display on the selection screen information about the video along with the title of the video.

### BACKGROUND

### Field of the Technology

The present disclosure relates to a video distribution system, a storage medium, and a video distribution method.

### Description of the Related Art

A video distribution system that distributes video contents to mobile devices such as smartphones and/or tablet terminals that are operated by users has been known. In a streaming media service disclosed in US Patent Publication No. US2012/0198088 (US 2012/0198088 A1), a user interface (a UI) for reproducing a video content is displayed on a display unit of a mobile device, and for example, a list of titles of video contents that are candidates for selection (that are selection candidates) is displayed on this UI. The user selects preferred video content from this list and reproduces the selected preferred video content.

In the technique disclosed in US 2012/0198088 A1, since only the titles of the video contents that are the selection candidates are displayed on the UI, there is room for improvement in terms of ease of selecting a preferred video content.

### SUMMARY

The present disclosure provides a method for displaying a selection screen that enables suitable selection of video contents.

According to an aspect of the present disclosure, a video distribution system provides a service for distributing videos, the system comprising a control unit configured to cause a display device of a mobile device to display a selection screen in a ranking format for enabling a user to select a video to be distributed. The control unit is further configured to cause the display device to display, on the selection screen together with a title of the video, at least one of the following items of information (i) to (v) as information about the video: (i) a cumulative viewing time of the video during a predetermined period and a number of viewers currently viewing the video; (ii) positive and negative ratings of the video; (iii) a rate of increase in a number of viewings of the video, a period during which a rank of the video is maintained, and a deviation between the rank and a subsequent rank in the ranking; (iv) a country or region with a largest number of viewers of the video; or (v) an age group or gender with a largest number of viewers of the video.

Features of the present disclosure will become apparent from the following description of embodiments with reference to the attached drawings. The following description of embodiments is described by way of example.

### BRIEF DESCRIPTION OF THE DRAWINGS

FIG. 1 is a network configuration diagram illustrating an example of a network configuration of a video distribution system according to an embodiment of the present disclosure.

FIG. 2 is a block diagram schematically illustrating a configuration of a video distribution server shown in FIG. 1.

FIG. 3 is a diagram illustrating an example of a viewer information management table (a user information management table) stored in a storage shown in FIG. 2.

FIG. 4 is a diagram illustrating an example of a video content management table stored in the storage shown in FIG. 2.

FIG. 5 is a block diagram that schematically illustrates a configuration of a mobile device shown in FIG. 1.

FIG. 6 is a sequence diagram illustrating the procedure of a streaming distribution control processing performed by the video distribution server and the mobile device that are shown in FIG. 1.

FIG. 7 is a diagram illustrating an example of a viewing video selection screen displayed on an operation display unit shown in FIG. 5.

FIG. 8 is a diagram illustrating an example of a viewing video reproduction screen displayed on the operation display unit shown in FIG. 5.

FIG. 9 is a diagram illustrating an example of a comment input screen displayed on the operation display unit shown in FIG. 5.

FIG. 10 is a flowchart illustrating the procedure of the processing performed by the mobile device in the streaming distribution control processing shown in FIG. 6.

FIG. 11 is a flowchart illustrating the procedure of the processing performed by the video distribution server in the streaming distribution control processing shown in FIG. 6.

FIG. 12 is a diagram illustrating an example of a setting screen displayed on the operation display unit shown in FIG. 5.

FIG. 13 is a diagram for explaining display control of the viewing video selection screen relating to a recommendation function in the embodiment of the present disclosure.

### DESCRIPTION OF THE EMBODIMENTS

The present disclosure will now be described in detail below with reference to the accompanying drawings showing embodiments thereof.

An embodiment of the present disclosure will be described with reference to the drawings. Before describing a video distribution system according to the embodiment of the present disclosure, the roles of a video distribution server that constitutes a video distribution system and a mobile device that communicates with the video distribution server will be described. The video distribution server retains a plurality of video contents and provides segment files in response to a request received from the mobile device. The video distribution server encodes the video content to generate segment files, and provides these segment files at various bit rates, enabling the mobile device to select the optimal bit rate depending on the network conditions. The video distribution server receives feedback from the mobile device and performs the optimization of distribution. The mobile device is a terminal operated by a user who wants to view the video content (a user who views the video content). The mobile device analyzes the manifest file, selects an appropriate bit rate, downloads the segment files, and reproduces (plays back) the video content based on the downloaded segment files. The mobile device changes the reproduction position (the playback position) of the video content and switching the bit rate in response to user operations.

The configuration of a video distribution system 100 according to the embodiment of the present disclosure will now be described.

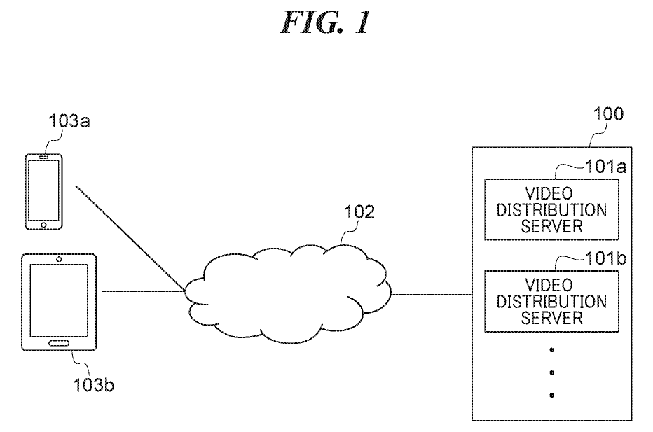

FIG. 1 is a network configuration diagram illustrating an example of a network configuration of the video distribution system 100 according to the embodiment of the present disclosure.

As illustrated in FIG. 1, the video distribution system 100 communicates with a plurality of mobile devices, such as a mobile device 103a and a mobile device 103b, via a network 102.

The video distribution system 100 provides a video distribution service that distributes video contents that includes movies, TV programs, animations, dramas, and the like. The video distribution system 100 is configured to include a plurality of video distribution servers, such as a video distribution server 101a and a video distribution server 101b, and these video distribution servers are distributed and located in different countries and regions, respectively. The video distribution system 100 performs encoding with respect to the video content to convert it into a video file in a format suitable for transfer, and distributes the video file to the video distribution servers around the world by using a content delivery network (a CDN). In response to a request received from a mobile device, the video distribution system 100 distributes segment files of the video content by streaming to the mobile device from a video distribution server located in the country or region to which the mobile device belongs. As a result, for example, users in different countries, such as Japan, the United States, and India, can view the same video content in real time.

In streaming distribution, for example, protocols such as HTTP Live Streaming (HLS) and Dynamic Adaptive Streaming over HTTP (DASH) are used. These protocols split the video content into small segment files. The mobile device downloads and reproduces the segment files as needed. The HLS is a protocol developed by Apple® and is particularly compatible with iOS devices. The DASH is a protocol developed by the international standardization organization MPEG and is compatible with a wider range of devices. Both the protocols support adaptive bitrate streaming, which allows the bit rate to be dynamically changed depending on the network conditions.

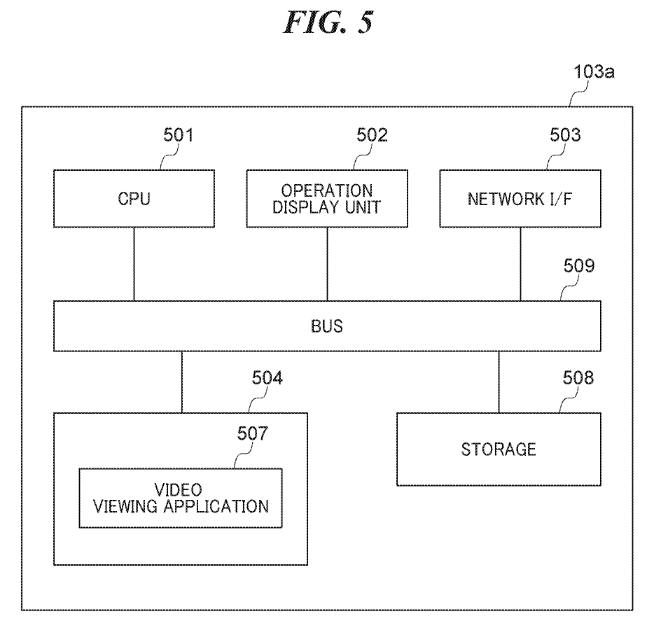

The mobile device 103a and the mobile device 103b are, for example, smartphone(s) and/or tablet terminal(s). A video viewing application 507 illustrated in FIG. 5, which will be described below and which is an application for using the video distribution service, is installed on the mobile device 103a and the mobile device 103b. For example, when the video viewing application 507 is started on the mobile device 103a, the mobile device 103a uses a web browser function of the video viewing application 507 to obtain display data for a screen (a web page) that enables the user to select a video content to be viewed from the video distribution server 101a located in the country or region to which the mobile device 103a belongs. The mobile device 103a obtains, from the video distribution server 101a, segment files corresponding to the video content selected by the user on the screen (the web page) displayed based on the obtained display data. The mobile device 103a causes an operation display unit 502 illustrated in FIG. 5, which will be described below, to display this video content based on the obtained segment files.

Next, the configurations of the video distribution server 101a and the video distribution server 101b in the video distribution system 100 will be described. In the present embodiment, since the video distribution server 101a and the video distribution server 101b have the same configuration, the configuration of the video distribution server 101a will be described as an example for convenience purposes.

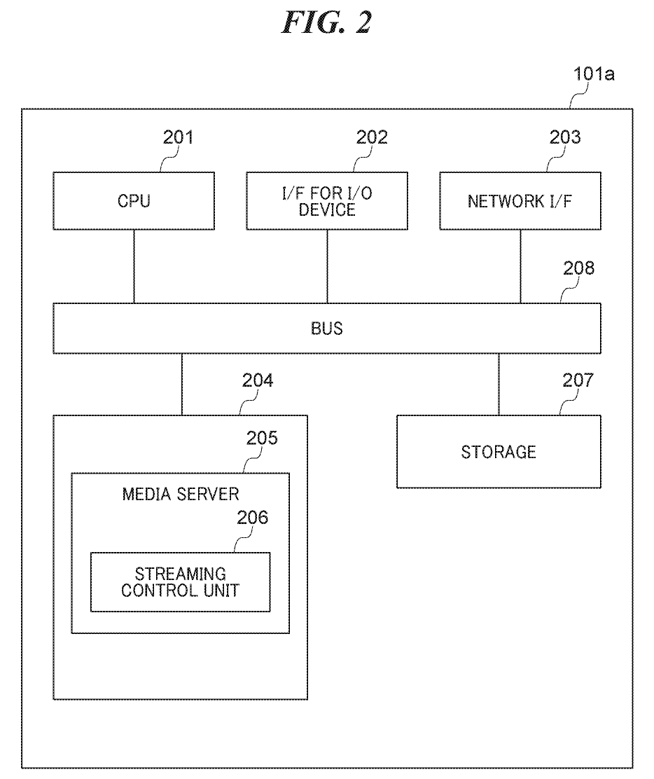

FIG. 2 is a block diagram that schematically illustrates the configuration of the video distribution server 101a illustrated in FIG. 1.

As illustrated in FIG. 2, the video distribution server 101a includes a central processing unit (CPU) 201, an interface (I/F) 202 for I/O device, a network I/F 203, a memory 204, and a storage 207. The CPU 201, the I/F 202 for I/O device, the network I/F 203, the memory 204, and the storage 207 are connected to each other via a bus 208.

The CPU 201 executes programs that stored in the memory 204. The CPU 201 is configured by a single CPU, multiple CPUs, a single CPU with multiple processing cores, or the like.

A keyboard (not shown), a display device (not shown), and a mouse (not shown), for example, are connected to the I/F 202 for I/O device.

The network I/F 203 is an interface that enables the video distribution server 101a to communicate with other communication devices via the network 102.

The memory 204 is configured by a random access memory. The memory 204 includes, for example, a media server 205 as a software module.

The media server 205 includes a streaming control unit 206 and operates when the CPU 201 executes a control program for the media server 205. In response to a request received from a mobile device such as the mobile device 103a or the mobile device 103b, the streaming control unit 206 transmits, to the mobile device, display data for a screen that enables the user to select a video content to be viewed. In addition, when the streaming control unit 206 receives, from the mobile device, a request to reproduce (play back) the video content selected by the user on this screen, the streaming control unit 206 obtains, from the storage 207, a video file obtained by performing encoding with respect to the video content selected by the user on this screen. The streaming control unit 206 transmits, to the mobile device, segment files obtained by splitting the obtained video file.

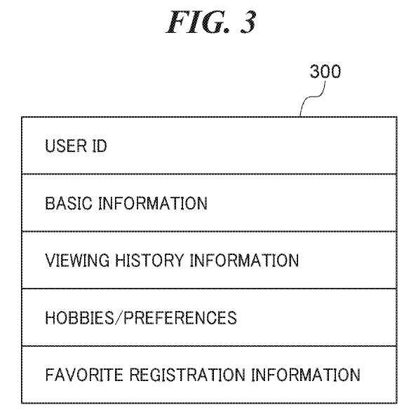

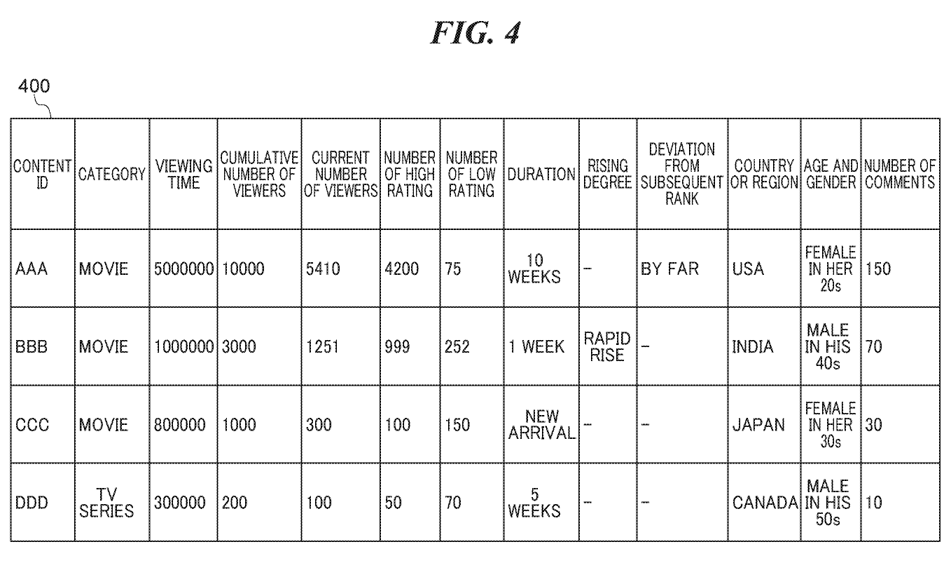

The storage 207 is configured with a non-volatile storage device such as a hard disk drive (an HDD) or a solid state drive (an SSD). The storage 207 stores a plurality of video files obtained by performing encoding with respect to each of video contents managed by the video distribution server 101a. In addition, the storage 207 stores a user information management table 300 illustrated in FIG. 3 and a video content management table 400 illustrated in FIG. 4.

Next, the user information management table 300 and the video content management table 400 that are managed by the video distribution server 101a and the video distribution server 101b, respectively, will be described. In the present embodiment, the video distribution server 101a and the video distribution server 101b manage information about the country or region in which the video distribution server 101a and the video distribution server 101b is located. For example, the video distribution server 101a manages, based on the user information management table 300, information about users belonging to the country or region where the video distribution server 101a is located. In addition, the video distribution server 101a manages, based on the video content management table 400, information about video contents that have been viewed in the country or region where the video distribution server 101a is located.

FIG. 3 is a diagram illustrating an example of the user information management table 300 stored in the storage 207 illustrated in FIG. 2.

The user information management table 300 is a management table for managing information about users who have performed use registration of the video distribution service in the country or region where the video distribution server 101a is located.

As illustrated in FIG. 3, the user information management table 300 is configured to include items such as a user ID, basic information, viewing history information, hobbies/preferences, and favorite registration information. The configuration of the user information management table 300 is an example, and the user information management table 300 may include additional items.

The user ID is an identifier assigned to a user who has performed the use registration of the video distribution service. The basic information includes age, gender, etc. of the user who performed the use registration of the video distribution service. The viewing history information includes information indicating a video content that the user has viewed through the video distribution service, the amount of time the user has viewed the video content, information indicating how the user has rated the video content, etc. The hobbies/preferences are information set in advance by the user, and include, for example, information indicating the types of video contents that the user prefers. The favorite registration information is information indicating video contents that the user has registered as favorites.

Based on the above, in the present embodiment, the video distribution server 101a creates and manages a plurality of user information management tables 300 corresponding to the respective users who have performed the use registration of the video distribution service in the country or region where the video distribution server 101a is located. Similarly, the video distribution server 101b also creates and manages a plurality of user information management tables 300 corresponding to the respective users who have performed the use registration of the video distribution service in the country or region where the video distribution server 101b is located. In the present embodiment, while the configuration in which information about each user is managed by using a different user information management table 300 for each user will be described, a configuration in which information about all users who have performed the use registration of the video distribution service is managed by using one management table may be adopted.

FIG. 4 is a diagram illustrating an example of the video content management table 400 stored in the storage 207 illustrated in FIG. 2.

The video content management table 400 is a management table for managing the information about the video contents viewed in the country or region where the video distribution server 101a is located.

As illustrated in FIG. 4, the video content management table 400 is configured to include items such as a content ID, a category, a viewing time, the cumulative number of viewers, the current number of viewers, the number of high rating, the number of low rating, a duration, a rising degree, a deviation from the subsequent rank, a country or region, age and gender, and the number of comments. The configuration of the video content management table 400 is an example, and the video content management table 400 may include additional items.

The content ID is an identifier assigned to a video content to be distributed by the video distribution service. The category is information indicating the category of this video content, such as “movie”, “TV series”, “English language work”, “non-English language work”, or the like.

The viewing time is a cumulative time that the users who belong to the country or region where the video distribution server 101a is located have viewed this video content. In the present embodiment, the video distribution system 100 determines ranking of popular video contents based on this viewing time for each predetermined period, for example, every week, and controls the display of the screen that enables the user to select a video content to be viewed based on the rank of this ranking.

The cumulative number of viewers is the cumulative number of users who have viewed this video content in the country or region where the video distribution server 101a is located. The current number of viewers is the number of users currently viewing this video content in the country or region where the video distribution server 101a is located. The number of high rating is the total number of high rating provided by users who belong to the country or region where the video distribution server 101a is located and who have viewed this video content. The number of low rating is the total number of low rating provided by users who belong to the country or region where the video distribution server 101a is located and who have viewed this video content. The duration is a period during which the rank of this video content continues at the same rank. The rising degree is information indicating the degree of rising from the previous ranking, and with respect to a video content whose rank or viewing time has risen by more than a predetermined value since the previous ranking, “rapid rise” indicating that effect is set.

The deviation from the subsequent rank is information indicating the degree of a difference between the viewing time of a video content whose ranking is the first place and the viewing time of a video content whose ranking is the second place. In the case where the difference between the viewing time of the video content whose ranking is the first place and the viewing time of the video content whose ranking is the second place is greater than or equal to a threshold value “by far” indicating that effect is set. The country or region is information indicating the country or region of users who have most viewed this video content. The age and gender are information indicating age and gender of users who have most viewed this video content in the country or region where the video distribution server 101a is located. The number of comments is the total number of comments input by the users who have viewed this video content in the country or region where the video distribution server 101a is located.

In the present embodiment, the video distribution server 101a creates and manages the video content management table 400 that includes the information about the video contents viewed in the country or region where the video distribution server 101a is located. Similarly, the video distribution server 101b also creates and manages the video content management table 400 that includes information about video contents viewed in the country or region where the video distribution server 101b is located.

Next, the configuration of the mobile device that communicates with the video distribution system 100 will be described. In the present embodiment, the configuration of the mobile device 103a, which is a smartphone, will be described as an example of the mobile device.

FIG. 5 is a block diagram that schematically illustrates the configuration of the mobile device 103a illustrated in FIG. 1.

As illustrated in FIG. 5, the mobile device 103a includes a CPU 501, the operation display unit 502 (display device), a network I/F 503, a memory 504, and a storage 508. The CPU 501, the operation display unit 502, the network I/F 503, the memory 504, and the storage 508 are connected to each other via a bus 509.

The CPU 501 executes programs stored in the memory 504. The CPU 501 is configured by a single CPU, multiple CPUs, a single CPU with multiple processing cores, or the like.

The operation display unit 502 is a touch panel type display. The network I/F 503 is an interface that enables the mobile device 103a to communicate with other communication devices via the network 102. For example, the network I/F 503 receives segment files transmitted from the video distribution server 101a or the like.

The memory 504 is configured by a random access memory. The memory 504 includes, for example, the video viewing application 507 as a software module.

The video viewing application 507 is an application for using the video distribution service. The video viewing application 507 includes the web browser function. In the mobile device 103a, the display of a screen based on the display data provided from the video distribution server 101a or the like is realized by the web browser function of the video viewing application 507.

In addition, the video viewing application 507 realizes the reproduction (playback) of a video content based on an encoded video file stored in the storage 508. For example, the video viewing application 507 is configured to reproduce Adobe® Flash® files, Microsoft® Silverlight® packages, or packages that perform streaming of media such as HTML5 objects. The storage 508 stores segment files received from the video distribution server 101a or the like.

Next, a series of processing performed by the video distribution system 100 to streaming-distribute a video content to the mobile device will be described. In the present embodiment, as an example, the processing performed when the video distribution server 101a in the video distribution system 100 streaming-distributes a video content to the mobile device 103a, will be described. In the present embodiment, other video distribution servers such as the video distribution server 101b and the like also perform similar processing to streaming-distribute video contents to the mobile devices.

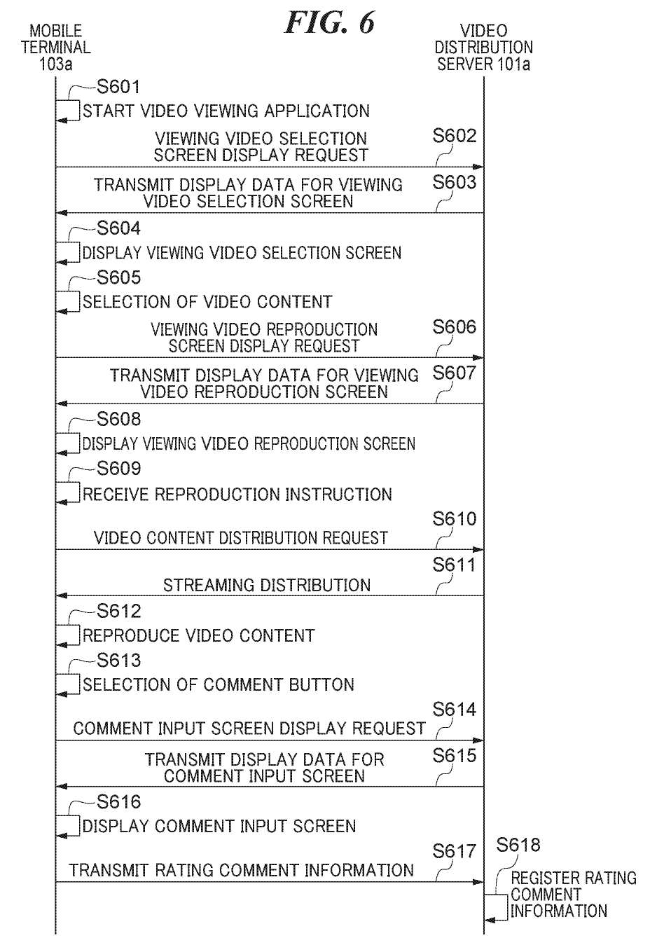

FIG. 6 is a sequence diagram illustrating the procedure of a streaming distribution control processing performed by the video distribution server 101a and the mobile device 103a that are illustrated in FIG. 1. The processing performed by the video distribution server 101a in the streaming distribution control processing is realized by the CPU 201 executing a program stored in the memory 204 or the like. In addition, the processing performed by the mobile device 103a in the streaming distribution control processing is realized by the CPU 501 executing a program stored in the memory 504 or the like. The streaming distribution control processing is started when the mobile device 103a receives, from the user, an instruction to start the video viewing application 507 (a start instruction of the video viewing application 507).

As illustrated in FIG. 6, first, the mobile device 103a starts the video viewing application 507 based on the start instruction of the video viewing application 507 from the user (S601). The subsequent processing performed by the mobile device 103a is controlled by the video viewing application 507.

Next, the mobile device 103a makes a request to display a viewing video selection screen (a viewing video selection screen display request) to the video distribution server 101a (S602). The viewing video selection screen display request includes information indicating the user of the mobile device 103a, for example, a user ID assigned when the user of the mobile device 103a has performed the use registration of the video distribution service.

In response to the viewing video selection screen display request, the video distribution server 101a generates display data for the viewing video selection screen. For example, the video distribution server 101a determines the configuration of the viewing video selection screen based on the video content management table 400. In addition, the video distribution server 101a determines the configuration of the viewing video selection screen based on the user information management table 300 corresponding to the user ID included in the viewing video selection screen display request. The configuration of the viewing video selection screen will be described below. The video distribution server 101a transmits the generated display data to the mobile device 103a (S603). The configuration of causing the operation display unit 502 of the mobile device 103a to display the viewing video selection screen by transmitting this display data to the mobile device 103a is an example of a control unit.

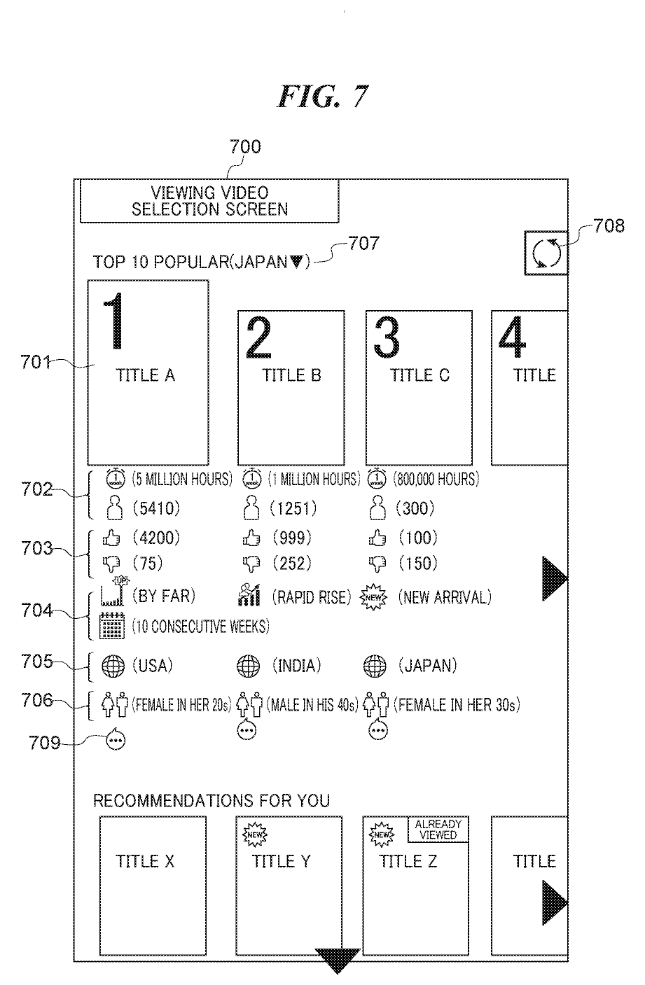

The mobile device 103a receives the display data by using the video viewing application 507. The mobile device 103a causes the operation display unit 502 to, based on the received display data, display a viewing video selection screen 700 illustrated in FIG. 7 (S604).

The viewing video selection screen 700 displays information about popular video contents in the form of ranking. Specifically, based on the rank of the ranking of the popular video contents, which has been determined based on the viewing time included in the video content management table 400, icons including titles of the video contents are arranged transversely in order from the left side of the viewing video selection screen 700. An icon 701 of the video content whose rank is the first place is displayed in a larger size than the icons of the video contents that have ranks other than the first place.

The viewing video selection screen 700 includes, as information about each of the video contents, first information 702, second information 703, third information 704, fourth information 705, and fifth information 706. The first information 702 is a cumulative viewing time viewed during a predetermined period and the number of viewers currently viewing, and is information based on the viewing time and the current number of viewers that are included in the video content management table 400. The second information 703 is information about positive rating and negative rating, and is information based on the number of high rating and the number of low rating that are included in the video content management table 400. The third information 704 is information about a rate of increase in the number of viewing, a period during which the rank of the video content continues, and information about a deviation between the rank and the subsequent rank, and the third information 704 is information based on the rising degree, the duration, and the deviation from the subsequent rank that are included in the video content management table 400. The fourth information 705 is information about the country or region with the largest number of viewers, and is information based on the country or region that is included in the video content management table 400. The fifth information 706 is information about an age group or gender with the largest number of viewers, and is information based on the age and gender that is included in the video content management table 400. When the user selects a comment mark 709, the user can view comments input by the users who have viewed the corresponding video content.

When the user performs a scroll right operation (a predetermined operation that scrolls to a side of information about the video content that has the subsequent rank) on the viewing video selection screen 700, the mobile device 103a obtains new display data from the video distribution server 101a. An icon of the video content that has the subsequent rank and the information about the video content that has the subsequent rank are also displayed on the viewing video selection screen 700 that is based on this new display data, an icon of the video content that has the subsequent rank and the information about the video content that has the subsequent rank are further displayed. When the user performs a scroll down operation (a predetermined operation that scrolls along a vertical direction of the viewing video selection screen 700) on the viewing video selection screen 700, the mobile device 103a obtains new display data from the video distribution server 101a. Icons of video contents related to categories other than the ranking of the popular video contents are displayed on the viewing video selection screen 700 that is based on this new display data,.

The viewing video selection screen 700 includes a setting button 707 for setting a country or region. In the present embodiment, an initial value of the setting button 707 has been set to the country or region to which the user who operates the mobile device 103a belongs. In this case, the rank of the ranking of the popular video contents, the first information 702, the second information 703, the third information 704, and the fifth information 706 are information that is based on the video content management table 400 in the country or region with the initial value. In the case where the user has designated another country or region by operating the setting button 707, the mobile device 103a transmits a request to update the viewing video selection screen 700 (an update request for the viewing video selection screen 700) to the video distribution server 101a along with information indicating the designated country or region. The video distribution server 101a obtains, from a server that manages the country or region indicated by the received information, for example, from the video distribution server 101b, display data generated based on the video content management table 400 managed by the video distribution server 101b. The video distribution server 101a transmits the obtained display data to the mobile device 103a. The mobile device 103a updates the viewing video selection screen 700 based on the received display data. Icons of the video contents are arranged transversely on the viewing video selection screen 700 updated, based on the rank of ranking of popular video contents in the country or region changed by the user. In addition, the information about each of the video contents (the first information 702, the second information 703, the third information 704, the fourth information 705, and the fifth information 706) is information that is based on the video content management table 400 in the country or region changed by the user.

The viewing video selection screen 700 includes an update button 708 for switching to the display of ranking based on a different criterion. When the user selects the update button 708, the mobile device 103a obtains new display data from the video distribution server 101a. Icons of the video contents are arranged transversely on the viewing video selection screen 700 that is based on this new display data, based on the rank of the ranking based on a different criterion. For example, when the user selects the update button 708 while information about ranking of movies has been displayed on the viewing video selection screen 700, the information is updated to information about ranking of another category such as “TV series”, “English language work”, “non-English language work”, or the like.

Returning to FIG. 6, when one icon is selected by the user from among the icons of the plurality of video contents on the viewing video selection screen 700 (S605), the streaming distribution control processing proceeds to S606.

In S606, the mobile device 103a makes a request to display a viewing video reproduction screen for reproducing the video content corresponding to the icon selected by the user (a viewing video reproduction screen display request) to the video distribution server 101a. The viewing video reproduction screen display request includes information indicating the video content selected by the user.

In response to the viewing video reproduction screen display request, the video distribution server 101a generates display data for the viewing video reproduction screen. The video distribution server 101a transmits the generated display data to the mobile device 103a (S607).

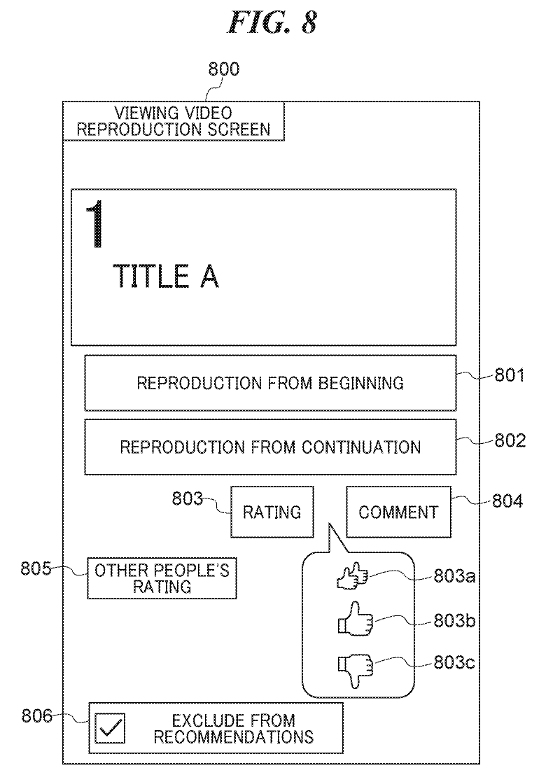

The mobile device 103a receives the display data by using the video viewing application 507. The mobile device 103a causes the operation display unit 502 to display, based on the received display data, a viewing video reproduction screen 800 illustrated in FIG. 8 (S608).

The viewing video reproduction screen 800 includes a reproduction from beginning button 801 for reproducing the video content from the beginning, and a reproduction from continuation button 802 for reproducing the video content from a continuation. The viewing video reproduction screen 800 also includes a rating button 803, a comment button 804, an other people's rating button 805, and a check box 806.

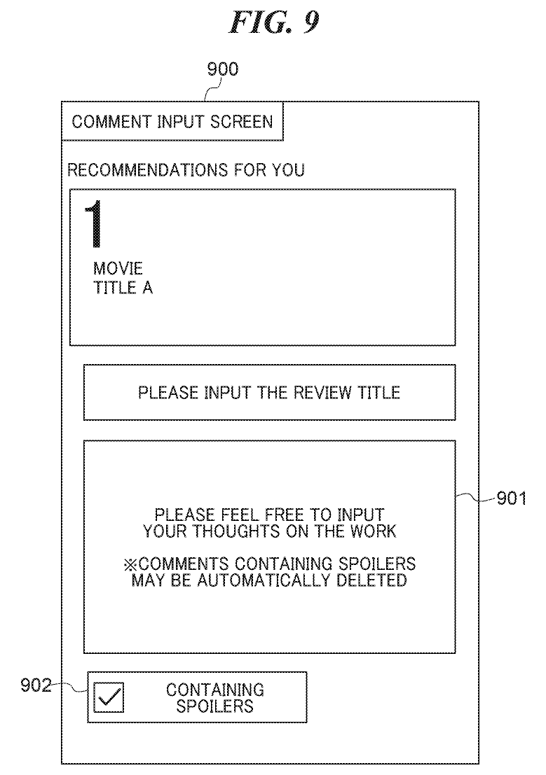

When the rating button 803 is selected, a highest rating button 803a, a high rating button 803b, and a low rating button 803c are displayed on the viewing video reproduction screen 800, and the user can select the highest rating button 803a, the high rating button 803b, or the low rating button 803c as the user’s rating for the video content. When the comment button 804 is selected, the screen of the operation display unit 502 switches to a comment input screen 900 illustrated in FIG. 9, which will be described below. When the other people's rating button 805 is selected, the user can check the ratings and comments that other users have input for this video content. When the check box 806 is checked, this video content is excluded from “recommendations for you”, which will be described below.

Returning to FIG. 6, when an instruction to reproduce the video content (a video content reproduction instruction) is received on the viewing video reproduction screen 800 (S609), the streaming distribution control processing proceeds to S610. In the present embodiment, the user can issue the video content reproduction instruction by pressing either the reproduction from beginning button 801 or the reproduction from continuation button 802.

In S610, the mobile device 103a makes a request to distribute the video content selected in S605 (a video content distribution request) to the video distribution server 101a. The video content distribution request includes information indicating the video content selected in S605.

Next, in response to the video content distribution request, the video distribution server 101a performs streaming distribution of the video content selected in S605 (S611). Specifically, the video distribution server 101a obtains, from the storage 207, an encoded video file of the video content selected in S605, and transmits, to the mobile device 103a, segment files of the video content selected in S605.

Next, the mobile device 103a reproduces, based on the received segment files, the video content selected in S605 (S612). As a result, the video content selected in S605 is displayed on the operation display unit 502 of the mobile device 103a. In the case where the reproduction (playback) of the video content is completed, or in the case where an instruction to stop the reproduction of the video content has been received from the user, the viewing video reproduction screen 800 is displayed on the operation display unit 502 of the mobile device 103a.

When the comment button 804 is selected by the user on the viewing video reproduction screen 800 (S613), the streaming distribution control processing proceeds to S614.

In S614, the mobile device 103a makes a request to display a comment input screen (a comment input screen display request) to the video distribution server 101a.

In response to the comment input screen display request, the video distribution server 101a generates display data for the comment input screen. The video distribution server 101a transmits the generated display data to the mobile device 103a (S615).

The mobile device 103a receives the display data by using the video viewing application 507. The mobile device 103a causes the operation display unit 502 to, based on the received display data, display the comment input screen 900 illustrated in FIG. 9 (S616).

The comment input screen 900 includes a comment input field 901 into which comments such as thoughts on the video content are input. The comment input screen 900 also includes a check box 902. The check box 902 is set by, for example, an administrator of the video distribution service, and cannot be changed by a user who views the video content. In the case where the check box 902 is checked, a determination processing of determining whether the comments that have been input into the comment input field 901 contain the content of spoilers is performed. The details of this determination processing will be described below.

When the mobile device 103a receives, from the user, an operation indicating the completion of inputting into the comment input field 901, the mobile device 103a transmits, to the video distribution server 101a, rating comment information including the comments input into the comment input field 901 (S617). In the case where the highest rating button 803a, the high rating button 803b, or the low rating button 803c on the viewing video reproduction screen 800 has been selected by the user, the rating comment information also includes rating information indicated by the button selected by the user from among the highest rating button 803a, the high rating button 803b, or the low rating button 803c.

Next, the video distribution server 101a registers the received rating comment information in a rating comment information management table (not shown) (S618). In the present embodiment, when the comment mark 709 on the viewing video selection screen 700 or the other people's rating button 805 on the viewing video reproduction screen 800 has been selected by the user, the ratings and comments on this video content are displayed based on information registered in the rating comment information management table. When the process of S618 is completed, the streaming distribution control processing ends.

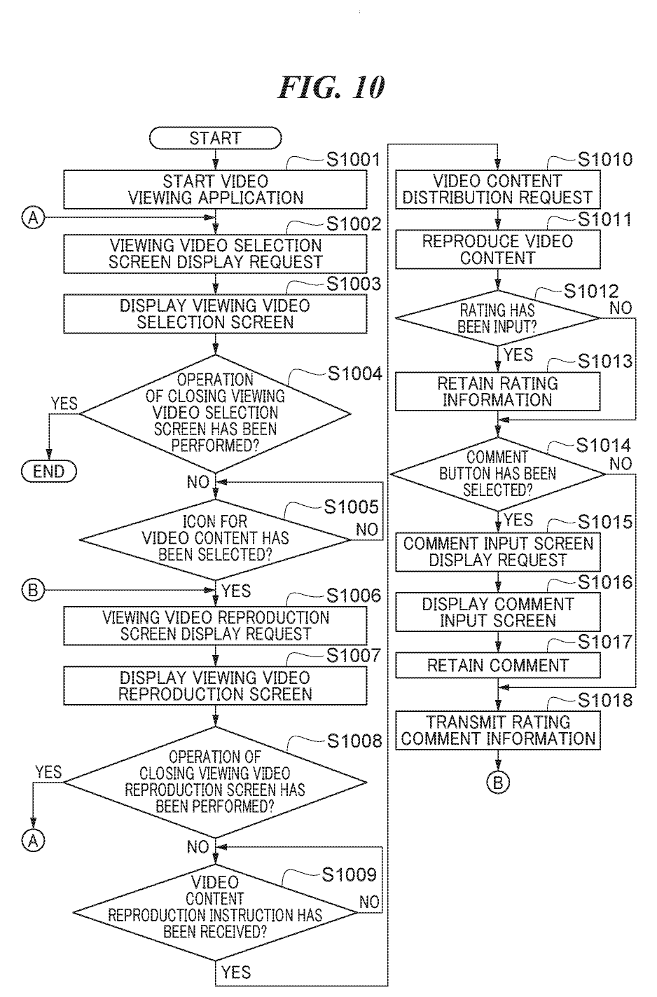

FIG. 10 is a flowchart illustrating the procedure of the processing performed by the mobile device 103a in the streaming distribution control processing illustrated in FIG. 6. The processing illustrated in FIG. 10 is realized by the CPU 501 executing the program stored in the memory 504 or the like. The processing illustrated in FIG. 10 is started when the mobile device 103a receives, from the user, an instruction to start the video viewing application 507 (a start instruction of the video viewing application 507).

As illustrated in FIG. 10, first, the CPU 501 executes a control program for the video viewing application 507 stored in the memory 504 to start the video viewing application 507 (S1001) (for example, see S601 described above). The subsequent processing in FIG. 10 is realized by the CPU 501 executing the control program for the video viewing application 507.

Next, the CPU 501 makes a viewing video selection screen display request to the video distribution server 101a (S1002) (for example, see S602 described above).

Next, the CPU 501 causes the operation display unit 502 to display the viewing video selection screen 700, based on the display data received from the video distribution server 101a by using the video viewing application 507 (S1003) (for example, see S604 described above).

The CPU 501 then determines whether an operation of closing the viewing video selection screen 700 has been received from the user (has been performed by the user) (S1004). If it is determined that an operation of closing the viewing video selection screen 700 has been received from the user (YES in S1004), the processing ends. If it is determined that an operation of closing the viewing video selection screen 700 has not been received from the user (NO in S1004), the processing proceeds to S1005.

In S1005, the CPU 501 determines whether the icon of the video content on the viewing video selection screen 700 has been selected by the user. The CPU 501 waits until the icon of the video content on the viewing video selection screen 700 is selected by the user. When the icon of the video content is selected by the user (YES in S1005) (for example, see S605 described above), the processing proceeds to S1006.

In S1006, the CPU 501 makes a request to display a viewing video reproduction screen for reproducing the video content selected in S1005 (a viewing video reproduction screen display request) to the video distribution server 101a (for example, see S606 described above).

Next, the CPU 501 causes the operation display unit 502 to display the viewing video reproduction screen 800, based on the display data received from the video distribution server 101a, by using the video viewing application 507 (S1007) (for example, see S608 described above).

The CPU 501 then determines whether an operation of closing the viewing video reproduction screen 800 has been received from the user (has been performed by the user) (S1008). If it is determined that an operation of closing the viewing video reproduction screen 800 has been received from the user (YES in S1008), the processing returns to S1002. If it is determined that an operation of closing the viewing video reproduction screen 800 has not been received from the user (NO in S1008), the processing proceeds to S1009.

In S1009, the CPU 501 determines whether a video content reproduction instruction has been received from the user on the viewing video reproduction screen 800. The CPU 501 waits until a video content reproduction instruction is received from the user on the viewing video reproduction screen 800. When a video content reproduction instruction is received from the user (YES in S1009) (for example, see S609 described above), the processing proceeds to S1010.

In S1010, the CPU 501 makes a request to distribute the video content selected in S1005 (a video content distribution request) to the video distribution server 101a (for example, see S610 described above).

Next, the CPU 501 reproduces the video content selected in S1005, based on the segment files transmitted from the video distribution server 101a in response to this video content distribution request (S1011) (for example, see S612 described above). As a result, the video content selected in S1005 is displayed on the operation display unit 502 of the mobile device 103a. In the case where the reproduction (playback) of the video content is completed or in the case where an instruction to stop the reproduction of the video content has been received from the user, the viewing video reproduction screen 800 is displayed on the operation display unit 502 of the mobile device 103a.

Next, the CPU 501 determines whether a rating has been input (S1012). In the present embodiment, the user can input the user’s rating for the video content selected in S1005 by selecting the highest rating button 803a, the high rating button 803b, or the low rating button 803c that are displayed when the rating button 803 is selected. If it is determined that a rating has not been input (NO in S1012), the processing proceeds to S1014. If it is determined that a rating has been input (YES in S1012), the processing proceeds to S1013.

In S1013, the CPU 501 temporarily retains, in the memory 504 or the like, rating information indicating the rating that has been input. Next, the CPU 501 determines whether the comment button 804 on the viewing video reproduction screen 800 has been selected by the user (S1014). If it is determined that the comment button 804 on the viewing video reproduction screen 800 has not been selected by the user (NO in S1014), the processing proceeds to S1018. If it is determined that the comment button 804 on the viewing video reproduction screen 800 has been selected by the user (YES in S1014), the processing proceeds to S1015.

In S1015, the CPU 501 makes a comment input screen display request to the video distribution server 101a (for example, see S614 described above).

Next, the CPU 501 causes the operation display unit 502 to display the comment input screen 900, based on the display data received from the video distribution server 101a, by using the video viewing application 507 (S1016) (for example, see S616 described above).

When the CPU 501 receives, from the user, an operation indicating the completion of inputting into the comment input field 901, the CPU 501 temporarily retains, in the memory 504 or the like, the comments that have been input into the comment input field 901 (S1017).

Next, the CPU 501 transmits, to the video distribution server 101a, rating comment information including the rating information retained in S1013 and the comments that have been retained in S1017 (S1018) (for example, see S617 described above). In this way, in the present embodiment, the rating and the comments input by the user on the viewing video reproduction screen 800 are transmitted to the video distribution server 101a. In the case where the user does not input both the rating and the comments on the viewing video reproduction screen 800, in S1018, rating comment information that does not include the rating information and the comments may be transmitted to the video distribution server 101a. The control may be performed so that the rating comment information is not transmitted to the video distribution server 101a. When the process of S1018 is completed, the processing returns to S1006.

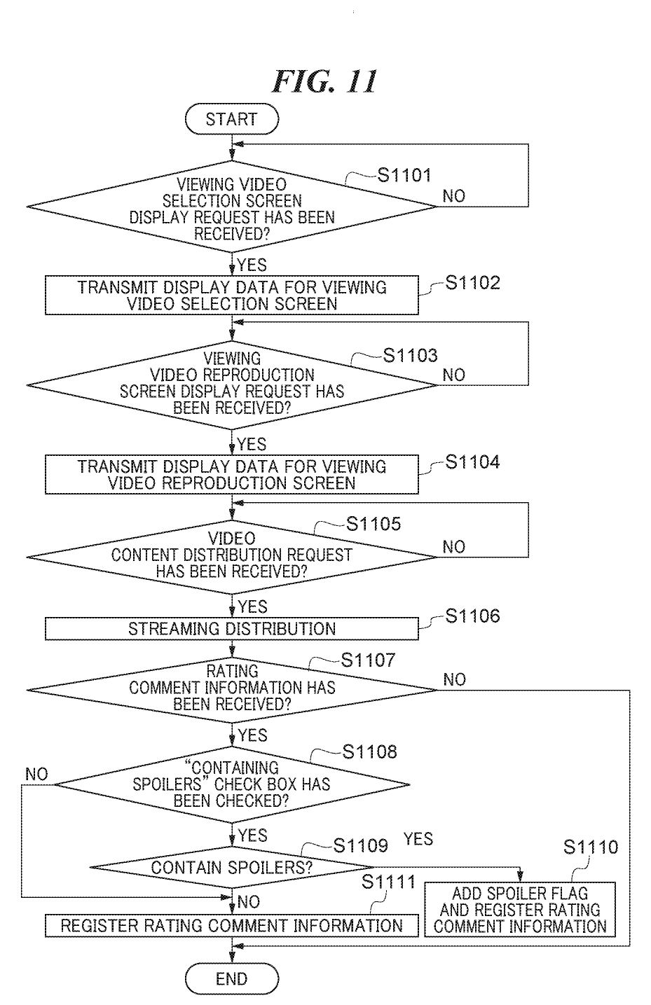

FIG. 11 is a flowchart illustrating the procedure of the processing performed by the video distribution server 101a in the streaming distribution control processing illustrated in FIG. 6. The processing illustrated in FIG. 11 is realized by the CPU 201 executing the program stored in the memory 204 or the like.

As illustrated in FIG. 11, first, the CPU 201 determines whether a viewing video selection screen display request has been received from the mobile device 103a(S1101). The CPU 201 waits until a viewing video selection screen display request is received from the mobile device 103a. For example, when a viewing video selection screen display request is received from the mobile device 103a, (YES in S1101), the CPU 201 generates display data for the viewing video selection screen based on this viewing video selection screen display request. For example, the CPU 201 determines the configuration of the viewing video selection screen based on the video content management table 400. In addition, the CPU 201 determines the configuration of the viewing video selection screen based on the user information management table 300 corresponding to the user ID included in the viewing video selection screen display request. Next, the CPU 201 transmits the generated display data to the mobile device 103a (S1102) (for example, see S603 described above).

Next, the CPU 201 determines whether a viewing video reproduction screen display request has been received from the mobile device (S1103). The CPU 201 waits until a viewing video reproduction screen display request is received from the mobile device 103a. For example, when a viewing video reproduction screen display request is received from the mobile device 103a (YES in S1103), the CPU 201 generates display data for the viewing video reproduction screen based on this viewing video reproduction screen display request. Next, the CPU 201 transmits the generated display data to the mobile device 103a (S1104) (for example, see S607 described above).

The CPU 201 then determines whether a video content distribution request has been received from the mobile device 103a (S1105). The CPU 201 waits until a video content distribution request is received from the mobile device 103a. For example, when a video content distribution request is received from the mobile device 103a (YES in S1105), the CPU 201 performs streaming distribution of the video content corresponding to this video content distribution request (S1106) (for example, see S611 described above). Specifically, the CPU 201 obtains, from the storage 207, an encoded video file of this video content, and transmits, to the mobile device 103a, segment files of this video content.

Next, the CPU 201 determines whether rating comment information has been received from the mobile device 103a (S1107). If it is determined that rating comment information has not been received from the mobile device 103a (NO in S1107), the processing ends. If it is determined that rating comment information has been received from the mobile device 103a (YES in S1107), the processing proceeds to S1108.

In S1108, the CPU 201 determines whether the check box 902 has been checked on the comment input screen 900 displayed on the mobile device that transmitted the rating comment information, for example, on the mobile device 103a. For example, the determination in S1108 is made based on information obtained from the mobile device 103a and can identify the check status of the check box 902. In the case of being determined that the check box 902 has been checked on the comment input screen 900 displayed on the mobile device 103a (YES in S1108), the processing proceeds to S1109.

In S1109, the CPU 201 uses generative artificial intelligence (generative AI) trained with the stories of all video contents that can be distributed through the video distribution service to determine whether the comments, which are included in the rating comment information obtained in S1107, contain the content of spoilers. The video distribution server 101a may use the generative AI that operates by executing a program stored in the storage 207 or the like to make the determination in S1109. The video distribution server 101a may request another apparatus equipped with this generative AI to make a determination on the rating comment information obtained in S1107, and may make the determination in S1109 based on a response to this request from the another apparatus. If it is determined that the comments, which are included in the rating comment information obtained in S1107, contain the content of spoilers (YES in S1109), the processing proceeds to S1110.

In S1110, the CPU 201 adds a spoiler flag to the rating comment information obtained in S1107, and registers, in the rating comment information management table, the rating comment information to which the spoiler flag has been added. The spoiler flag is a flag indicating that the content of spoilers is contained. In the present embodiment, when the comment mark 709 on the viewing video selection screen 700 or the other people's rating button 805 on the viewing video reproduction screen 800 has been selected by the user, among the comments on the corresponding video content registered in the rating comment information management table, only comments to which the spoiler flag has not been added are displayed. In this way, in the present embodiment, the control is performed so that the comments containing the content of spoilers are not displayed. The processing in FIG. 11 then ends.

If it is determined in S1109 that the comments, which are included in the rating comment information obtained in S1107, do not contain the content of spoilers (NO in S1109), the processing proceeds to S1111. If it is determined in S1108 that the check box 902 has not been checked on the comment input screen 900 displayed on the mobile device 103a (NO in S1108), the processing proceeds to S1111.

In S1111, the CPU 201 registers, in the rating comment information management table, the rating comment information obtained in S1107. The processing in FIG. 11 then ends.

According to the above-described embodiment, on the viewing video selection screen 700, the first information 702, the second information 703, the third information 704, the fourth information 705, and the fifth information 706, which are information about a video content, are displayed together with the title of the video content. As a result, it is possible to provide the viewing video selection screen 700, which includes information other than the title, as information about a video content that is a selection candidate, and therefore it becomes possible to help the user in selecting a video content.

In addition, in the above-described embodiment, on the viewing video selection screen 700, the icon of the video content whose ranking is the first place is displayed in a larger size than the icons of the video contents that have other ranks other than the first place. As a result, the user can easily recognize the video content whose ranking is the first place from the viewing video selection screen 700.

In addition, in the above-described embodiment, since the viewing video selection screen 700 includes the setting button 707, the user can select the user’s preferred video content from information about popularity ranking in the country or region other than the country or region to which the user belongs.

In the above-described embodiment, since the viewing video selection screen 700 includes the update button 708, the user is able to select his/her preferred video content from information about popularity ranking based on a different criterion.

In the above-described embodiment, the video distribution system 100 causes the operation display unit 502 of the mobile device to display the comment input screen 900. As a result, as information to be used for helping the user in selecting a video content, it is possible to collect comments such as thoughts on each of the video contents.

In addition, in the above-described embodiment, on the viewing video selection screen 700, the comments, which have been input via the comment input screen 900, are displayed. As a result, the user can select the user’s preferred video content based on the comments displayed on the viewing video selection screen 700.

In the above-described embodiment, in the case where the comments, which are included in the rating comment information, contain the content of spoilers, the video distribution system 100 causes not to display these comments. As a result, it is possible to prevent spoilers caused by the display of the comments such as thoughts on the video contents while helping the user in selecting a video content.

In the above-described embodiment, while the configuration has been described in which a spoiler flag is added to rating comment information containing the content of spoilers and the rating comment information containing the content of spoilers, to which the spoiler flag has been added, is registered in the rating comment information management table, the present disclosure is not limited to this configuration. For example, the control may be performed so that the rating comment information containing the content of spoilers is not registered in the rating comment information management table.

In the above-described embodiment, while the configuration has been described in which the video distribution server 101a performs determining whether the content of spoilers is contained at a timing when the rating comment information is received from the mobile device, the present disclosure is not limited to this configuration. For example, a configuration may be adopted in which at a timing when inputting comments into the comment input field 901 is completed, the mobile device 103a uses the generative AI described above to determine whether the comments contain the content of spoilers. For example, in the case of being determined that the comments contain the content of spoilers, the rating comment information that does not include the comments is transmitted to the video distribution server 101a. As a result, it is possible to reliably prevent comments containing the content of spoilers from being registered in the rating comment information management table, and therefore it becomes possible to prevent the comments containing the content of spoilers from being displayed.

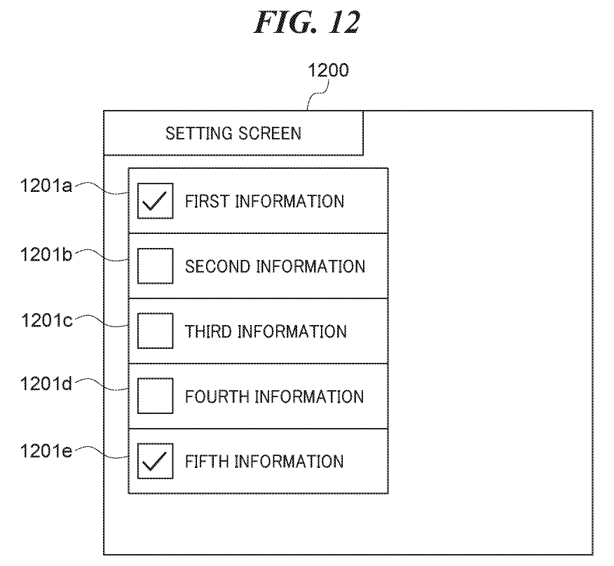

In addition, in the above-described embodiment, each of the video distribution servers that constitute the video distribution system may be configured to provide a setting screen 1200 illustrated in FIG. 12 to the mobile device. The setting screen 1200 is a screen enabling the user to set which of the first information 702, the second information 703, the third information 704, the fourth information 705, and the fifth information 706 is to be displayed on the viewing video selection screen 700. The setting screen 1200 includes check boxes 1201a to 1201e corresponding to the first information 702, the second information 703, the third information 704, the fourth information 705, and the fifth information 706, respectively. Information corresponding to checked items (the checked check boxes) from among the check boxes 1201a to 1201e is displayed on the viewing video selection screen 700. For example, with the setting shown in FIG. 12, the first information 702 and the fifth information 706 from among the first information 702, the second information 703, the third information 704, the fourth information 705, and the fifth information 706 are displayed on the viewing video selection screen 700. This configuration enables providing information that makes it easier for the user to select the user’s preferred video content on a mobile device such as a smartphone whose operation display unit 502 is relatively small in size.

Next, a recommendation function provided in the video distribution system 100 will be described.

The video distribution system 100 includes the recommendation function that suggests recommended video contents to users who use the video distribution service. The recommendation function suggests recommended video contents to a user who uses the video distribution service, based on information such as the viewing history information and the hobbies/preferences that are included in the user information management table 300 for the user who uses the video distribution service.

Specifically, on the viewing video selection screen 700 described above, as “recommendations for you”, based on a recommendation order determined based on the viewing history information and the hobbies/preferences, icons of the recommended video contents are arranged transversely in order from the left side of the viewing video selection screen 700. In the present embodiment, as the user continues to view the video contents, the viewing history information is added to the user information management table 300, and the recommendation function places more importance on recent viewing trends than on past viewing trends. A mark indicating that effect, for example, “New” is added to an icon for a video content newly added as a recommendation.

Even though the recommendation function places importance on the recent viewing trends, since video contents that are not the user's preferred video contents may be displayed as recommendations, there is room for improvement in terms of making it easier for the user to select the user’s preferred video content.

To address this issue, in the present embodiment, the control is performed so that the video content set by the user to be excluded from recommendations is not displayed as a recommendation. Specifically, each of the video distribution servers in the video distribution system 100 generates display data for the viewing video selection screen 700 in which the icon of the video content, for which the check box 806 on the viewing video reproduction screen 800 has been checked, has been excluded from “recommendations for you”, and transmits the generated display data to the mobile device. For example, before viewing a video content, when the user realizes from other users' ratings of this video content that this video content is not the user’s preferred work, the user checks the check box 806 on the viewing video reproduction screen 800 for this video content. As a result, from the next time onwards, other video contents other than this video content can be suggested as recommendations, which increases the possibility that the user's preferred video contents will be suggested as recommendations.

In the present embodiment, the control may be performed so that the icon of the video content for which the check box 806 has been checked and icons of video contents with the same attribute as the video content for which the check box 806 has been checked are not included in “recommendations for you” of the viewing video selection screen 700. Here, the attribute refers to a category that is classified based on a common feature or theme, such as horror works or works that include violent scenes. As a result, it is also possible to exclude video contents in the same genre as the video content for which the check box 806 has been checked from recommendations, and therefore it is possible to further increase the possibility that the user's preferred video contents will be suggested as recommendations.

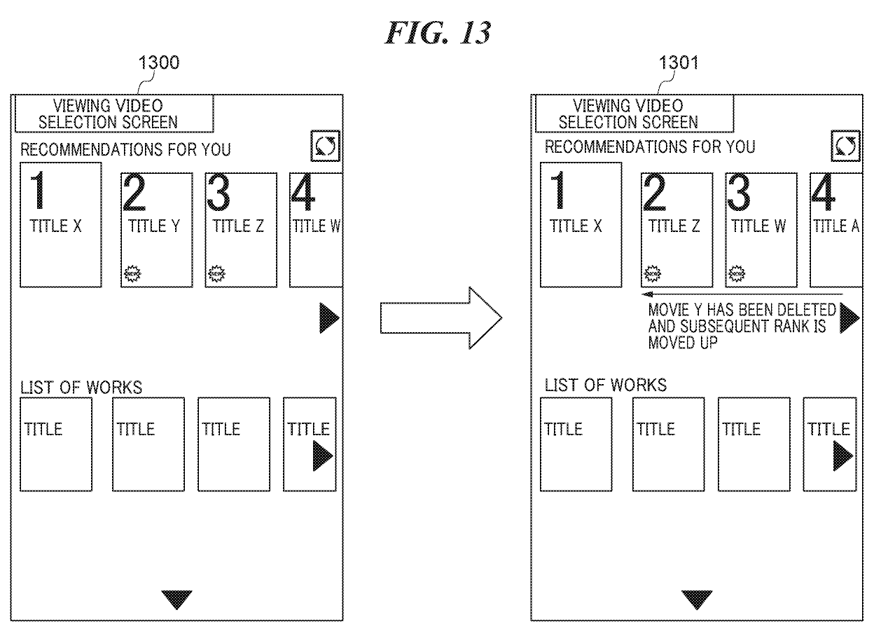

In the present embodiment, the control to exclude, from “recommendations for you”, icons of video contents that have not been selected by the user for a certain period of time from among the icons that have been displayed in “recommendations for you” of the viewing video selection screen 700 may be performed. For example, the video distribution server 101a generates display data for a viewing video selection screen 1300 illustrated in FIG. 13 in response to a request received from the mobile device 103a, and transmits, to the mobile device 103a, the generated display data for the viewing video selection screen 1300. Thereafter, for example, in the case where only an icon of a title Y has not been selected by the user for a certain period of time, the video distribution server 101a generates display data for a viewing video selection screen 1301 illustrated in FIG. 13, in which the icon of the title Y that has not been selected for the certain period of time since the display data for the viewing video selection screen 1300 has been transmitted has been excluded from “recommendations for you”, and transmits, to the mobile device 103a, the generated display data for the viewing video selection screen 1301. By performing the control in this way, it is possible to prevent the video content that the user is not interested in from continuing to be displayed as a recommendation.

In addition, in the present embodiment, the control to exclude, from “recommendations for you”, an icon of a video content that the user has input a negative rating from among the icons that have been displayed in “recommendations for you” of the viewing video selection screen 700 may be performed. For example, the video distribution server 101a generates display data for the viewing video selection screen 1300 in response to a request received from the mobile device 103a, and transmits, to the mobile device 103a, the generated display data for the viewing video selection screen 1300. Thereafter, for example, in the case where the user has selected the low rating button 803c on the viewing video reproduction screen 800 for the title Y, the video distribution server 101a generates display data for the viewing video selection screen 1301, in which the icon of the title Y has been excluded from “recommendations for you”, and transmits, to the mobile device 103a, the generated display data for the viewing video selection screen 1301. By performing the control in this way, it is possible to prevent the video content that the user has set to a low rating from continuing to be displayed as a recommendation.

In addition, in the present embodiment, as information indicating that the user has selected, “already viewed” may be displayed on an icon selected by the user from among the icons that have been displayed in “recommendations for you”. As a result, the user can easily identify the icon that the user has selected from among the icons of the multiple video contents that have been displayed in “recommendations for you”, and therefore it is possible to prevent the user from unintentionally selecting the same video content multiple times.

In the present embodiment, the viewing video reproduction screen 800 may also include a check box for causing to display “already viewed”. “Already viewed” is displayed on the icon of the video content for which the check box for causing to display “already viewed” has been checked from among the icons displayed in “recommendations for you”. As a result, the user can easily identify the icon that the user has confirmed (checked) once from among the icons of the multiple video contents displayed in “recommendations for you”, and therefore it is possible to prevent the user from unintentionally selecting the same video content multiple times.

In the present embodiment, in the icon containing “already viewed”, “New” indicating that it is a video content newly added as a recommendation may be added as it is, or the control may be performed so that “New” is removed.

According to the present disclosure, it is possible to suitably select video content.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-232156, filed December 27, 2024, which is hereby incorporated by reference herein in its entirety.

What is claimed is:

1. A video distribution system that provides a service for distributing videos, the system comprising:
a control unit configured to cause a display device of a mobile device to display a selection screen in a ranking format for enabling a user to select a video to be distributed, and
wherein the control unit is further configured to cause the display device to display, on the selection screen together with a title of the video, at least one of the following items of information (i) to (v) as information about the video:
(i) a cumulative viewing time of the video during a predetermined period and a number of viewers currently viewing the video;
(ii) positive and negative ratings of the video;
(iii) a rate of increase in a number of viewings of the video, a period during which a rank of the video is maintained, and a deviation between the rank and a subsequent rank in the ranking;
(iv) a country or region with a largest number of viewers of the video; or
(v) an age group or gender with a largest number of viewers of the video.

2. The video distribution system according to claim 1, wherein
the control unit causes to display an icon of a title whose ranking is a first place from among a plurality of titles displayed on the selection screen in a larger size than icons of titles that have ranks other than the first place.

3. The video distribution system according to claim 1, wherein
a setting button for setting a country or region is displayed on the selection screen, and
the information (i), (ii), (iii), and (v) displayed on the selection screen as the information about the video is information about viewers in the country or region set by the setting button.

4. The video distribution system according to claim 1, wherein
an update button for switching to a display of ranking based on a different criterion is displayed on the selection screen.

5. The video distribution system according to claim 1, wherein
the control unit causes the display device of the mobile device to display an input screen for inputting comments on a viewed video.

6. The video distribution system according to claim 5, wherein
the inputted comments are displayed on the selection screen.

7. The video distribution system according to claim 6, wherein
the control unit, in a case where the inputted comments include a comment related to the content of the viewed video, causes the display device of the mobile device not to display the comment related to the content of the viewed video.

8. The video distribution system according to claim 1, wherein
information about each of the videos is transversely displayed on the selection screen based on a rank of the ranking, and
the control unit, when a predetermined operation that scrolls the selection screen in a direction in which information about the video having a next lower rank is displayed has been accepted on the selection screen, causes the display device of the mobile device to display the selection screen, on which the information about the video that has the subsequent rank has been displayed.

9. The video distribution system according to claim 8, wherein the rank of the ranking is determined based on an amount of time viewed in a designated country or region during the predetermined period.

10. The video distribution system according to claim 1, wherein the control unit causes the display device of the mobile device to display a setting screen for setting which of the information (i) to (v) is to be displayed on the selection screen.

11. The video distribution system according to claim 1, wherein the control unit, when a predetermined operation that scrolls along a vertical direction of the selection screen has been accepted on the selection screen, causes the display device of the mobile device to display the selection screen, on which titles related to categories other than the ranking have been displayed.

12. The video distribution system according to claim 1, wherein the predetermined period is one week.

13. A non-transitory computer-readable storage medium storing a program for causing a computer to execute a method for providing a service for distributing videos, the method comprising:
causing a display device of a mobile device to display a selection screen in a ranking format for enabling a user to select a video to be distributed by the service, and
wherein as information about the video, at least one of the following items of information (i) to (v) is caused to be displayed on the selection screen together with a title of the video:
(i) a cumulative viewing time of the video during a predetermined period and a number of viewers currently viewing the video;
(ii) positive and negative ratings of the video;
(iii) a rate of increase in a number of viewings of the video, a period during which a rank of the video is maintained, and a deviation between the rank and a subsequent rank in the ranking;
(iv) a country or region with a largest number of viewers of the video; or
(v) an age group or gender with a largest number of viewers of the video.

14. A video distribution method that distributes a video, the video distribution method comprising:
causing a display device of a mobile device to display a selection screen in a ranking format for enabling a user to select the video, and
wherein as information about the video, at least one of the following items of information (i) to (v) is caused to be displayed on the selection screen together with a title of the video:
(i) a cumulative viewing time of the video during a predetermined period and a number of viewers currently viewing the video;
(ii) positive and negative ratings of the video;
(iii) a rate of increase in a number of viewings of the video, a period during which a rank of the video is maintained, and a deviation between the rank and a subsequent rank in the ranking;
(iv) a country or region with a largest number of viewers of the video; or
(v) an age group or gender with a largest number of viewers of the video.
